(19) United States
(12) Patent Application Publication
(10) Pub. No.: US 2024/0157590 A1
(43) Pub. Date: May 16, 2024

(54) WET SHAVE RAZOR CARTRIDGE HAVING BLADE SLOTS

(71) Applicant: Edgewell Personal Care Brands, LLC, Chesterfield, MO (US)

(72) Inventor: Andrew Hitchcock, Bethany, CT (US)

(73) Assignee: Edgewell Personal Care Brands, LLC, Chesterfield, MO (US)

(21) Appl. No.: 18/552,376

(22) PCT Filed: Mar. 18, 2022
(86) PCT No.: PCT/US22/20861

§ 371 Date: Sep. 25, 2023

Related U.S. Application Data
(60) Provisional application No. 63/170,788, filed on Apr. 5, 2021.

(51) Int. Cl. B26B 21/22; B26B 21/40; B26B 21/44; B26B 21/56

(52) U.S. Cl. CPC B26B 21/222; B26B 21/4018; B26B 21/4025; B26B 21/443; B26B 21/565

(57) ABSTRACT

A razor cartridge includes a frame and a razor blade. The frame includes a guard, a cap, an opening configured to receive a razor blade, and a blade-receiving slot. The blade-receiving slot includes a front support and a rear support. The front support includes a front side surface and a front blade locating surface. The rear support includes a rear side surface and a rear blade locating surface. The front side surface and the rear side surface are coplanar. The front blade locating surface and the rear blade locating surface extend from the coplanar side surfaces in generally opposite directions. The razor blade includes an edge portion and a support portion that are bent at an angle relative to one another. The support portion of the razor blade is positioned in the slot. A clip may be utilized to retain the razor blade in the slot.

### BACKGROUND OF THE DISCLOSURE

### Technical Field

The present disclosure relates generally to wet shave razor cartridges, and to wet shave razor cartridges having slots for retaining razor blades therein in particular.

### Background Information

Wet shave razors are well-known in the art. There are numerous known configurations in which razor blades have been positioned in a frame in commercial embodiments. In many instances, either bent blades or flat razor blades that are welded to bent blade supports are positioned in a frame for shaving. In order to maintain the desired position of the razor blades in the frame, while still permitting rinse through passages between the blades, blade slots are often utilized at various positions across the length of the frame. A portion of each bent blade or bent blade support is positioned in the slot. The blades may be held firmly in the frame so that there is little to no relative movement between the razor blade and the frame during use. Alternatively, the razor blades may be dynamically supported in the frame by the slots but permitted to move a pre-determined amount under forces encountered during shaving.

The above known designs, however, have shortcomings. For example, the designs were difficult to adjust once a frame mold tool was made. Slight adjustments were difficult to make, and often required an entirely new mold tool to be constructed. This and other shortcomings in the prior art are addressed by the present disclosure as disclosed herein.

### SUMMARY

According to one aspect of the present disclosure, a wet shave razor cartridge and a frame for the same includes the frame and a razor blade. The frame includes a guard at a front region extending in a longitudinal direction, a cap at a rear region also extending in the longitudinal direction, opposed side walls extending between the guard and the cap, an opening between the guard and the cap and extending in the longitudinal direction between the opposed side walls, and a blade-receiving slot. The slot is positioned between a front support at a guard side and a rear support at a cap side. The razor blade has an edge portion and a support portion mounted in the opening such that the edge portion extends in the longitudinal direction. The edge portion is angularly bent relative to the support portion. The front support has a front side surface extending perpendicularly to the longitudinal direction and a front blade locating surface extending from the front side surface in a first direction along the longitudinal direction. The rear support has a rear side surface extending perpendicularly to the longitudinal direction and a rear blade locating surface extending from the rear side surface in a second direction along the longitudinal direction. The second direction is opposite the first direction. The front side surface and the rear side surface are coplanar. A portion of the support portion of the razor blade is positioned in the blade-receiving slot.

According to another aspect of the present disclosure, the razor blade includes a bent blade support with the edge portion affixed (e.g., welded) thereto. Alternatively, the edge portion and the support portion of the razor blade are formed of a unitary piece of material that is bent. Preferably, the sides of the edge portion and the support portion are free of burrs.

According to further aspect of the present disclosure, the blade is positioned within two or more slots arranged in a row in the frame.

According to an even further aspect of the present disclosure, the slot is positioned in a manner such that it is spaced away from the sidewall.

According to an even further aspect of the present disclosure, the front support includes an angled top support that is positioned adjected an underside of the edge portion of the razor blade.

According to an even further aspect of the present disclosure, a clip is positioned on the frame such that an underside of the clip is positioned in contact with a portion of the edge portion of the razor blade.

According to an even further aspect of the present disclosure, a second blade positioned in the opening aft of the first blade.

According to an even further aspect of the present disclosure, one slot that supports the second blade is positioned directly behind a slot that supports the forwardmost blade when the cartridge is viewed from the front. The various similar features (e.g., front blade locating surface, side surfaces, and rear blade locating surface) of the slot supporting the second blade are in alignment with the similar features of the slot immediately in front thereof when the cartridge is viewed from the front. In a more further aspect, the front side surface and the rear side surface for the slot for the first razor blade are coplanar within a first plane. The front side surface and the rear side surface for the slot for the second razor blade are coplanar within a second plane, parallel to and offset from the first plane.

One advantage of the present disclosure is the blades can be easily loaded into the frame during assembly and held firmly in place with one or two bent metal clips.

Another advantage of the present disclosure is that the designer may make tool adjustments easily and cost-effectively due to the offset between the front blade locating surfaces and rear blade locating surfaces. Small adjustments can be made to the position of the blade locating surfaces without altering other aspects of the mold tool or the need to rebuild substantial portions of the mold.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a plan view of a razor cartridge of the present disclosure;

FIG. 2 is a transverse sectional view of FIG. 1 along line 2-2;

FIG. 3 is another transverse sectional view of FIG. 1 along line 3-3;

FIG. 4 is an isometric view of the frame of a cartridge of the present disclosure;

FIG. 5 is a plan view of the frame of FIG. 4;

FIG. 6 is an enlarged partial view of Area 6 of FIG. 5;

FIG. 7 is a side sectional view of FIG. 5 along line 7-7;

FIG. 8 is a side sectional view of FIG. 1 along line 8-8; and

FIG. 9 is an enlarged partial view of another frame, taken at a similar position to FIG. 6.

### DETAILED DESCRIPTION OF THE DISCLOSURE

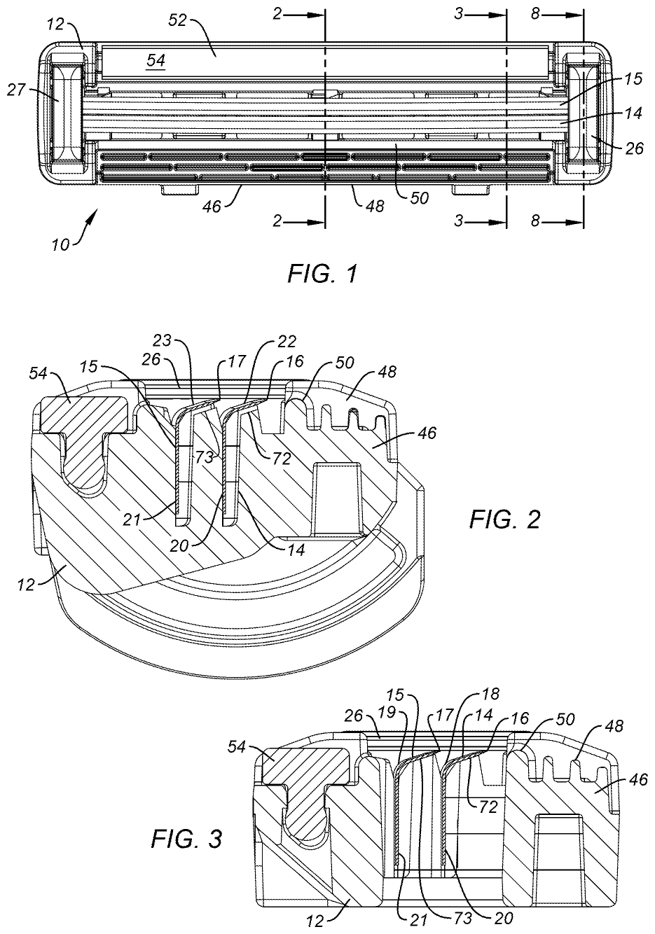

Referring to FIGS. 1 and 2, a wet shave razor cartridge 10 is shown. The razor cartridge 10 includes a frame 12, one or more blades 14,15, and blade retention clips 26,27.

Referring to FIG. 2, two blades 14,15 are positioned in the frame 12. Preferably the blades 14,15 are the bent blade type, manufactured from a single strip of metal. On one side, a cutting edge 16, 17 is provided and the strip is formed to include a bend 18,19 to provide structural stability necessary during the shaving process. Suitable manners of making a bent blade are disclosed in US Patent application publications 2007/0234577 and 2010/0107425, the teachings of which are hereby incorporated by reference. The resulting blade 14,15 includes a bend 18,19 that separates a support portion 20 and an edge portion 22,23 bearing the cutting edges 16,17.

During manufacture of the bent blade 14,15, an elongated strip of flat material is often processed and then cut to the desired length for use in the razor cartridge 10 prior to or after bending. As a result of the length cutting process, in some cases, the extreme longitudinal ends of either or both of the support portion 20 and the edge portion 22 can include a burr or other undesirable feature that may disrupt the assembly process and/or intended operation of the blade 14,15 during use. Therefore, an additional operation of de-burring or otherwise smoothing one of the ends of the bent blade 14,15 may be desirable. The de-burring or smoothing operation can be performed before, during and/or after the bending of the razor blade 14,15 into the final shape.

Although bent blades 14,15 are shown in the provided figures, it is also known to provide a flat razor blade that is welded (or otherwise attached) to a separate bent blade support, e.g. as depicted as acknowledged prior art in the aforementioned 2007/0234577 publication.

Continuing to refer to FIG. 2, as shown includes two razor blades 14,15. The present disclosure is not so limited, and the wet shave razor cartridge 10 can include one (1) or three (3) to seven (7) razor blades 14,15 without departing from the scope of the present disclosure. In arrangements having more than one blade, it is possible to use more than one type of razor blade (e.g., one bent blade and one blade welded to a blade support), if desired.

Continuing to refer to FIG. 2, wet shave razor cartridges 10 are typically used in combination with a handle (not shown). The connection between the razor cartridge 10 and the handle may be either permanent (e.g., a so-called disposable razor product) or removable (e.g., system razor product). In addition, the connection between the razor cartridge 10 and the handle may be pivotable. As shown in FIG. 2, a shell bearing-type connection is shown on the frame 12 for attaching a handle thereto. However, the present disclosure is not to be considered to be so limited. For example, a pin-in-holes type of connection (not shown) can also provide the desired pivoting action between the razor cartridge 10 and the handle without departing from the scope of the present disclosure. Alternatively, the razor cartridge 10 can be mounted on a handle in a manner that prevents pivoting.

Referring to FIGS. 1-4 and 8, metal clips 26,27 can be utilized to assist with the retention of the razor blades 14,15 in the frame 12. The clips 26,27 are typically formed from a strip of metal that is bent into shape. The clips 26,27 wrap around a portion of the frame 12, maintaining the desired position of the razor blades 14,15 therein. As shown in FIG. 8, the legs 28,29 of the clips 26,27 may extend through holes in the frame with the tips 30,31 of the legs 28,29 bent outwards towards the front 32 (i.e., guard side) and rear 34 (i.e., cap side) of the frame 12. Alternatively, and although not shown, the tips 30,31 of legs 28,29 of the clips 26,27 may be bent inwards to achieve a similar effect. In addition, it is known to have one or both legs 28,29 of the clips 26,27 wrap around the outside of the frame 12, as well. The clips 26,27, as shown, are formed of two separate elements; however, in some arrangements, the clips 26,27 may be inter-connected and made of a unitary piece of material. The clips 26,27 may be formed of any suitable material, but it is well-known to form the clips 26, 27 of a metal such as aluminum.

Referring now to FIGS. 2 and 3, the underside of the clips 26,27 can be in contact with the cutting edges 16,17 and prevent the blades from undesirably ejecting from the razor cartridge 10 and also define the relative positioning of the cutting edges 16,17 as compared to the various other features of the razor cartridge 10. It is known that, by raising or lowering the cutting edges 16,17 relative to various other features of the razor cartridge 10, the designer can accomplish various degrees of closeness and/or comfort of the shave experience.

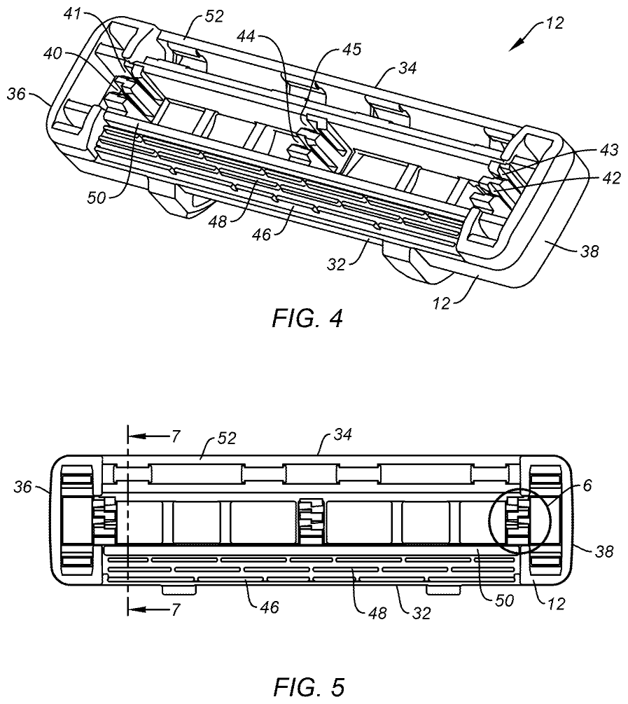

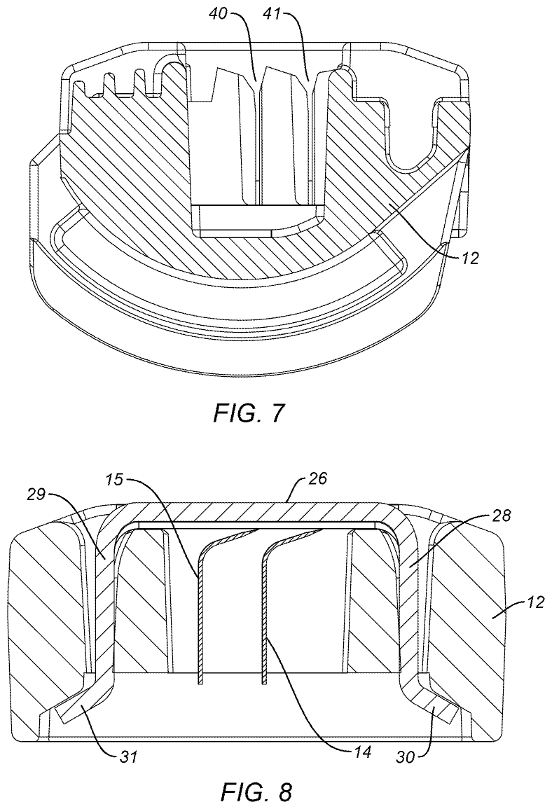

Referring now to FIGS. 4-8, the frame 12 is manufactured by injection molding a suitable thermoplastic polymer. For example, the frame 12 can be formed from ABS (acrylonitrile butadiene styrene) for benefits of chemical resistance (to substances typically found in use), impact resistance, and dimensional stability. Although shown as a unitary piece, the frame 12 may alternatively consist of several parts that are assembled. As shown, the frame 12 includes a front 32, a rear 34, a left side 36 and a right side 38. The frame 12, as shown, includes a series of left slots 40,41, right slots 42,43, and optionally center slots 44,45 that are configured to receive the razor blades 14,15 (see e.g., FIG. 2).

Referring to FIGS. 1 and 4, at the front 32 of the frame 12 is the guard 46. The guard 46 typically includes a rubberized (elastomeric), or similar, feature that is attached to the frame 12. In many cases, the guard 46 includes one or more flexible fins 48 that engage with and stretch the skin prior to the skin encountering the razor blades 14,15. The guard 46 often also includes a geometry setting member 50 that sets the position of the skin just prior to approaching the first blade 14 of the razor cartridge 10.

Continuing to refer to FIGS. 1 and 4, at the rear 34 of the razor cartridge 12 is the cap 52, which typically includes a lubrication strip 54 (FIG. 1). The lubrication strip 54 preferably deposits a shaving aid, such as polyethylene oxide, onto the skin immediately after the hair has been shaved from the skin by the razor blades 14,15.

The frame 12 includes respective slots configured to receive a portion of the support portion 20,21 of the razor blades 14,15 therein. As shown, a series of slots 40,42,44 are positioned in alignment in the longitudinal direction for the forwardmost blade 14. The series of slots includes a slot 40 positioned on the left side of the frame 12, an optional slot 44 in the middle of the frame, and a slot 42 on the right side of the frame 12. Although three (3) slots are shown for use in conjunction with the forwardmost blade, one (1), two (2) or four (4) or more slots can be utilized. A similar and separate series of the slots 41,43,45 is shown positioned immediately aft of the first series of slots 40,42,44 for use with the razor blade 15 positioned aft of the forwardmost razor blade 14.

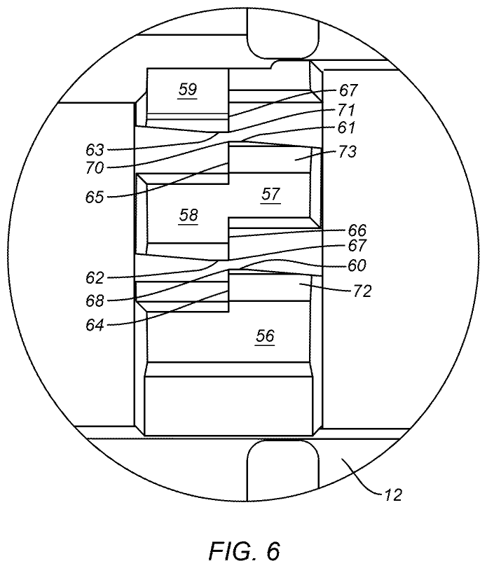

Referring now to FIG. 6, the slot 42,43 for the forwardmost razor blade 14 and the razor blade 15 aft of the forwardmost razor blade 14 on the right side of the frame 12 are shown. The slot 42 for the forwardmost razor blade 14 is bounded on the front (i.e., guard side) by a front support 56 and on the rear (i.e., cap side) by a rear support 58. The front support 56 includes a front blade locating surface 60 that is adjacent the front of the support portion 20 of the razor blade 14, and a side surface 64 that, as shown, faces inward towards the middle of the frame 12. The rear support 58 includes a rear blade locating surface 62 that is adjacent the rear of the support portion 20 of the razor blade 14, and a side surface that 66, as shown, faces outward and away from the middle of the frame 12. The side surface 64 of the front support 56 and the side surface 66 of the rear support 58 are coplanar. The front blade locating surface 60 and the rear blade locating surface 62 extend from the coplanar side surfaces 64,66 in opposite directions so that, when the frame 12 is viewed from the front (i.e., guard side), the front blade locating surface 60 and rear blade locating surface 62 are off-set, and do no overlap. Preferably, the corners 68,69 where the front and rear side surface 64,66 meet the respective blade locating surfaces 60,62 are sharp. In the context of the present disclosure the term “sharp” is intended to mean that no corner radius is intentionally provided at corners 68,69. Due to e.g. shrinkage of the material of the frame 12 immediately after molding a very small but measurable radius may be found.

The slot 43 for the razor blade 15 aft of the forwardmost razor blade 14 is also bounded on the front by a front support 57 and on the rear by a rear support 59. As shown, the front support 57 for the razor blade 15 aft of the forwardmost razor blade 14 is unitary with the rear support 58 for the forwardmost razor blade 14. The front support 57 for the second blade 15 includes a front blade locating surface 61 that is adjacent the front of the support portion 21 of the razor blade 15, and a side surface 65 that, as shown, faces inward towards the middle of the frame 12. The rear support 59 includes a rear blade locating surface 62 that is adjacent the rear of the support portion 21 of the razor blade 15, and a side surface 67 that, as shown, faces outward and away from the middle of the frame 12. The side surface 65 of the front support 56 and the side surface 67 of the rear support 69 are coplanar. The front blade locating surface 61 and the rear blade locating surface 63 extend from the coplanar side surfaces 65,67 in opposite directions so that, when the frame 12 is viewed from the front, the front blade locating surface 61 and rear blade locating surface 63 are off-set and do no overlap. Preferably, the corners 70,71 where the front and rear side surface 65,67 meet the respective blade locating surface 61,63 are sharp.

Preferably, when the frame 12 is viewed from the front (i.e., the guard side), the similar features for the slots are all in alignment, i.e., the coplanar side surfaces of both slots, the rear blade locating surfaces of both slots, and the front blade locating surfaces of both slots.

As shown, the slots 40,41 on the left side of the frame 12 are a mirror image of the slots 42,43 on the right side of the frame 12. Alternatively, although not shown, the slots 42,43 on the right side can be identical to the slots 40,41 on the left side. In addition, the slots 42,43 on the right side can be reversed from the orientation shown in FIG. 6.

Referring to FIGS. 2 and 3, the front supports 56,57 for the blades 14,15 preferably include an angled top support surface 72,73 that is complementary to the angle of the edge portions 22,23 of the blades 14,15 and provide support from below the razor blades 14,15 during use.

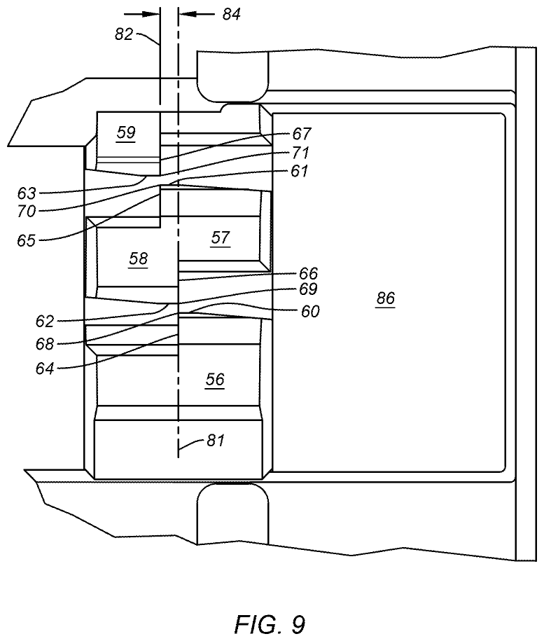

As shown in FIGS. 5 and 6, the slots at the left side 36 and the right side 38 of the frame 12 are inbound from the sides 36,38 of the frame 12. Therefore, when a blade 14,15 is positioned in the frame 12, the extreme longitudinal ends of the razor blades 14,15 are preferably positioned within the resultant openings 86 (see FIG. 9) between the slots 40,41,42,43 and the respective adjacent sides 36,38 of the frame 12, and directly underneath the clip(s) 26,27.

Referring now to FIG. 9, the slots 42,43 for the forwardmost razor blade and the next aft razor blade on the right side of an alternative frame 12 are shown. The slot 42 for the forwardmost razor blade 14 is bounded on the front (i.e., guard side) by a front support 56 and on the rear (i.e., cap side) by a rear support 58. The front support 56 includes a front blade locating surface 60 that is adjacent the front of the support portion 20 of the razor blade 14, and a side surface 64 that, as shown, faces inward towards the middle of the frame 12. The rear support 58 includes a rear blade locating surface 62 that is adjacent the rear of the support portion 20 of the razor blade 14, and a side surface that 66, as shown, faces outward and away from the middle of the frame 12. The side surface 64 of the front support 56 and the side surface 66 of the rear support 58 are coplanar within a first plane 81. The front blade locating surface 60 and the rear blade locating surface 62 extend from the coplanar side surfaces 64,66 in opposite directions so that, when the frame 12 is viewed from the front (i.e., guard side), the front blade locating surface 60 and rear blade locating surface 62 are off-set, and do no overlap. Preferably, the corners 68,69 where the front and rear side surface 64,66 meet the respective blade locating surfaces 60,62 are sharp.

The slot 43 for the next aft razor blade is also bounded on the front by a front support 57 and on the rear by a rear support 59. As shown, the front support 57 for the razor blade 15 aft of the forwardmost razor blade 14 is unitary with the rear support 58 for the forwardmost razor blade 14. The front support 57 for the second blade 15 includes a front blade locating surface 61 that is adjacent the front of the support portion 21 of the razor blade 15, and a side surface 65 that, as shown, faces inward towards the middle of the frame 12. The rear support 59 includes a rear blade locating surface 62 that is adjacent the rear of the support portion 21 of the razor blade 15, and a side surface 67 that, as shown, faces outward and away from the middle of the frame 12. The side surface 65 of the front support 56 and the side surface 67 of the rear support 69 are coplanar within a second plane 82. The front blade locating surface 61 and the rear blade locating surface 63 extend from the coplanar side surfaces 65,67 in opposite directions so that, when the frame 12 is viewed from the front, the front blade locating surface 61 and rear blade locating surface 63 are off-set and do no overlap. Preferably, the corners 70,71 where the front and rear side surface 65,67 meet the respective blade locating surface 61,63 are sharp. Planes 81 and 82 are parallel and offset 84.

Referring back to FIGS. 2 and 3, the width of the slots, as formed by the front blade locating surfaces and the rear blade locating surfaces, are preferably slightly wider than the width of the support portion of the razor blade such that the razor blades can be easily dropped into the slots. Alternatively, the slot width can be slightly narrower and the razor blades press fitted into the slots. In another alternative, the razor blades can be glued in the slots with a suitable adhesive, such as cyanoacrylate.

Continuing to refer to FIGS. 2 and 3, the depth of the slot can be deeper than the length of the support portion of the razor blade positioned therein. Alternatively, the slot may include a bottom feature on which the support portion sits during use.

In operation, the position of each razor blade 14,15 is partially maintained in the frame 12 by a combination of the underside of the clip 26,27 and the various slots into which the support portion 20,21 of the razor blade 14,15 is positioned. More specifically, the support portion 20,21 of the razor blade 14,15 is supported in each slot by the angled top surface 72,73 of the front support 56,57, the rear blade locating surface 62,63, and the front blade locating surface 60,61.

While various embodiments have been described above it should be understood that they have been presented by way of example only, and not limitation. For instance, modifications or changes as can be made within the scope of the attached claims and features disclosed in connection with any one embodiment can be used alone or in combination with each feature of the respective other embodiments. For example, while the present disclosure discloses blades that are intended to be held in place between the various slots features and the clip, the blades can also be dynamically positioned within the frame without departing from the scope of the disclosure. Thus, the breadth and scope of any embodiment should not be limited by any of the above-described exemplary embodiments but should be defined only in accordance with the following claims and their equivalents.

1. A razor cartridge, comprising:
a frame having:
a guard at a front region extending in a longitudinal direction,
a cap at a rear region also extending in the longitudinal direction,
opposed side walls extending between the guard and the cap,
an opening between the guard and the cap and extending in the longitudinal direction between the opposed side walls, and
a blade-receiving slot, the slot being positioned between a front support at a guard side and a rear support at a cap side;
a razor blade having an edge portion and a support portion mounted in the opening, the edge portion extending in the longitudinal direction and being angularly bent relative to the support portion;
wherein the front support has a front side surface extending perpendicularly to the longitudinal direction;
wherein the rear support has a rear side surface extending perpendicularly to the longitudinal direction;
wherein the front support has a front blade locating surface extending from the front side surface in a first direction along the longitudinal direction;
wherein the rear support has a rear blade locating surface extending from the rear side surface in a second direction along in the longitudinal direction, the second direction being opposite the first direction;
wherein the front side surface and the rear side surface are coplanar; and
wherein a portion of the support portion of the razor blade is positioned in the blade-receiving slot.

2. The razor cartridge of claim 1, wherein the razor blade includes a bent blade support with the edge portion affixed thereto.

3. The razor cartridge of claim 1, wherein the edge portion and the support portion of the razor blade are formed of a unitary piece of material.

4. The razor cartridge of claim 1, wherein the razor blade defines a first side and a second side, and one of the first and second sides is free of burrs.

5. The razor cartridge of claim 1 further comprising a second slot into which the razor blade is positioned.

6. The razor cartridge of claim 5 further comprising a third slot into which the razor blade is positioned.

7. The razor cartridge of claim 6, wherein the slots are spaced away from side walls.

8. The razor cartridge of claim 1, wherein the front support includes an angled top support that is positioned adjected an underside of the edge portion of the razor blade.

9. The razor cartridge of claim 1, wherein a clip is positioned on the frame such that an underside of the clip is positioned in contact with a portion of the edge portion of the razor blade.

10. The razor cartridge of claim 1, further comprising a second blade positioned in the opening aft of the first blade.

11. The razor cartridge of claim 10, wherein the frame includes one second blade slot into which a portion of a second blade support portion is positioned.

12. The razor cartridge of claim 11 wherein the frame includes a second second blade slot into which a portion of the second blade is positioned.

13. The razor cartridge of claim 12 wherein the frame includes a third second blade slot into which a portion of the second blade is positioned.

14. A razor cartridge, comprising:
a frame having:
a guard at a front region extending in a longitudinal direction,
a cap at a rear region also extending in the longitudinal direction,
opposed side walls extending between the guard and the cap,
an opening between the guard and the cap and extending in the longitudinal direction between the opposed side walls,
a first blade-receiving slot, the first slot being positioned between a first front support at a guard side and a first rear support at a cap side, and
a second blade-receiving slot, the second slot being positioned between a second front support at a guard side and a second rear support at a cap side
a first razor blade having a first edge portion and a first support portion mounted in the opening, the first edge portion extending in the longitudinal direction and being angularly bent relative to the first support portion;
a second razor blade having a second edge portion and a second support portion mounted in the opening, the second edge portion extending in the longitudinal direction and being angularly bent relative to the second support portion;
wherein the first front support has a first front side surface extending perpendicularly to the longitudinal direction;
wherein the second front support has a second front side surface extending perpendicularly to the longitudinal direction;
wherein the first rear support has a first rear side surface extending perpendicularly to the longitudinal direction;
wherein the second rear support has a second rear side surface extending perpendicularly to the longitudinal direction;
wherein the first front support has a first front blade locating surface extending from the first front side surface in a first direction along the longitudinal direction;
wherein the second front support has a second front blade locating surface extending from the second front side surface in the first direction;
wherein the first rear support has a first rear blade locating surface extending from the first rear side surface in a second direction along in the longitudinal direction, the second direction being opposite the first direction;
wherein the second rear support has a second rear blade locating surface extending from the second rear side surface in the second direction;
wherein a portion of the first support portion of the first razor blade is positioned in the first blade-receiving slot;
wherein the first front side surface, the first rear side surface, the second front side surface, and the second rear side surface are all coplanar; and
wherein a portion of the second support portion of the second razor blade is positioned in the second blade-receiving slot.

15. The razor cartridge of claim 14, wherein one of the first and second razor blades includes a bent blade support with the edge portion affixed thereto.

16. The razor cartridge of claim 14, wherein one of the first and second razor blades are formed of a unitary piece of material.

17. The razor cartridge of claim 14, wherein one of the first and second razor blades is free of burrs.

18. The razor cartridge of claim 14, wherein the first and second slots are spaced away from side walls.

19. The razor cartridge of claim 14, wherein a clip is positioned on the frame such that an underside of the clip is positioned in contact with a portion of the first edge portion and the second edge portion of the first and second razor blades, respectively.

20. The razor cartridge of claim 14, wherein a third razor blade is positioned in the frame aft of the second blade.

21. A razor cartridge frame, comprising:
a guard at a front region extending in a longitudinal direction,
a cap at a rear region also extending in the longitudinal direction,
opposed side walls extending between the guard and the cap,
an opening between the guard and the cap and extending in the longitudinal direction between the opposed side walls,
a first blade-receiving slot, the first slot being positioned between a first front support at a guard side and a first rear support at a cap side, and
a second blade-receiving slot, the second slot being positioned between a second front support at a guard side and a second rear support at a cap side
wherein the first front support has a first front side surface extending perpendicularly to the longitudinal direction;
wherein the second front support has a second front side surface extending perpendicularly to the longitudinal direction;
wherein the first rear support has a first rear side surface extending perpendicularly to the longitudinal direction;
wherein the second rear support has a second rear side surface extending perpendicularly to the longitudinal direction;
wherein the first front support has a first front blade locating surface extending from the first front side surface in a first direction along the longitudinal direction;
wherein the second front support has a second front blade locating surface extending from the second front side surface in the first direction;
wherein the first rear support has a first rear blade locating surface extending from the first rear side surface in a second direction along in the longitudinal direction, the second direction being opposite the first direction;
wherein the second rear support has a second rear blade locating surface extending from the second rear side surface in the second direction;
wherein the first front side surface, the first rear side surface, the second front side surface, and the second rear side surface are all coplanar.

22. A razor cartridge frame, comprising:
a guard at a front region extending in a longitudinal direction,
a cap at a rear region also extending in the longitudinal direction,
opposed side walls extending between the guard and the cap,
an opening between the guard and the cap and extending in the longitudinal direction between the opposed side walls,
a first blade-receiving slot, the first slot being positioned between a first front support at a guard side and a first rear support at a cap side, and
a second blade-receiving slot, the second slot being positioned between a second front support at a guard side and a second rear support at a cap side
wherein the first front support has a first front side surface extending perpendicularly to the longitudinal direction;
wherein the second front support has a second front side surface extending perpendicularly to the longitudinal direction;
wherein the first rear support has a first rear side surface extending perpendicularly to the longitudinal direction;
wherein the second rear support has a second rear side surface extending perpendicularly to the longitudinal direction;
wherein the first front support has a first front blade locating surface extending from the first front side surface in a first direction along the longitudinal direction;
wherein the second front support has a second front blade locating surface extending from the second front side surface in the first direction;
wherein the first rear support has a first rear blade locating surface extending from the first rear side surface in a second direction along in the longitudinal direction, the second direction being opposite the first direction;
wherein the second rear support has a second rear blade locating surface extending from the second rear side surface in the second direction;
wherein the first front side surface and the first rear side surface are coplanar within a first plane, the second front side surface and the second rear side surface are coplanar within a second plane, the second plane being parallel to, and offset from the first plane.
